(19) United States
(12) Patent Application Publication
(10) Pub. No.: US 2006/0279047 A1
(43) Pub. Date: Dec. 14, 2006

(54) Flange arrangement of an engine cylinder head and a method for producing the flange arrangement

(76) Inventors: Wilfried Bien, Seevetal-Emmelndorf (DE); Pierre Bonny, Hamburg (DE); Gerd Duerr, Neustadt (DE); Georg Georgs, Denkendorf (DE); Michael Halves, Hamburg (DE); Thomas Huelsberg, Buchholz/Holm Seppensen (DE); Joachim Karwath, Bad Liebenzell (DE); Uwe Kluessmann, Bispingen (DE); Holger Nuhn, Schneverdingen (DE); Ralf Puenjer, Seevetal (DE); Olav Reinhardt, Hamburg (DE); Dirk Riewert, Hamburg (DE); Thorsten Sternal, Moisburg (DE); Gerd Tiefenbacher, Stuttgart (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/564,659

(22) PCT Filed: Jul. 7, 2004
(86) PCT No.: PCT/EP04/07400

§ 371 Date: Jul. 17, 2006

(30) Foreign Application Priority Data
Jul. 12, 2003 (DE) 103 31 614.0

(51) Int. Cl. F02F 11/00

(52) U.S. Cl. 277/591; 123/193.3

(57) ABSTRACT

The invention relates to a flange arrangement (2, 14, 25) of an engine cylinder head (22) and to a process for producing it. To simplify them as much as possible without losing the functionality of the flange arrangement (2, 14, 25), it is proposed that the flange arrangement (2, 14, 25) have at least two single-piece individual flanges (1a-d, 13a-c, 26), which bear against one another with in each case at least one peripheral region (8a-d, 15, 20, 28, 29) overlapping, in such a manner that in the overlapping area their securing bores (3, 16, 27) for attaching them to the cylinder head (22) are aligned.

### CROSS REFERENCE TO RELATED APPLICATION

This application is a national stage of PCT/EP2004/007400 filed Jul. 7, 2004 and based upon DE 103 31 614.0 filed Jul. 12, 2003 under the International Convention.

### BACKGROUND OF THE INVENTION

### Field of the Invention

The invention relates to a flange arrangement in accordance with the preamble of patent claim 1, and to a process for producing it in accordance with the preamble of patent claim 8.

### SUMMARY OF THE INVENTION

A flange arrangement of the generic type and a process of the generic type for producing it are known from EP 0 918 148 A2. The flange arrangement described in that document comprises two flange layers which bear in lamellar form on top of one another, with each flange layer in turn comprising a plurality of partial flanges. The partial flanges of one layer in each case lie flat and flush next to one another. The middle partial flange of a layer has deformed peripheral regions which include securing holes and are adjoined by the outer partial flanges. The outer partial flanges do not have securing holes at this adjoining zone. In the second layer positioned on top, the distribution of the securing holes is precisely reversed. This means that in this case the outer partial flanges have deformed peripheral regions toward the middle partial flange, and these regions have securing holes. The middle partial flange adjoins these deformed peripheral regions of the outer partial flanges and does not have securing holes in this adjoining zone. Therefore, the deformed peripheral regions of the outer partial flanges of the latter layer overlap the deformed peripheral regions of the middle partial flange of the former layer. In this case, when fitting this flange arrangement to an engine cylinder head, the outer partial flanges of one layer are screwed to the middle partial flange of the other layer by means of in each case a common stud bolt.

A flange arrangement assembled in this manner has the drawback that on account of the large number of components which are required to assemble an arrangement of this type, it entails high production costs, let alone the considerable outlay on positioning required to arrange this multiplicity of individual flanges. A further particularly high cost in producing the arrangement is incurred through the fact that the individual flanges of the two layers have to be connected to one another, which requires an additional operation and is very cost-intensive. This operation is carried out, for example, by brazing, spot-welding and similar joining processes. Moreover, if a particularly inexpensive material is selected, corrosion may occur between the lamellae during the operating period of a flange arrangement of this type. This is the case in particular if the exhaust manifold, to which the flange arrangement is connected, is pressed into a pool of water to check for leak tightness. Furthermore, the individual flanges have tolerances in their thickness, and consequently functional disadvantages are likely in the event of an unfavorable tolerance pairing.

The invention is based on the object of developing a flange arrangement of the generic type and a process of the generic type in such a way that the production of the flange arrangement is simplified as much as possible without suffering any losses in functionality of the flange arrangement.

According to the invention, the object is achieved with regard to the flange arrangement with regard to the production process.

On account of the fact that the flange arrangement comprises at least two individual flanges, which are each formed as a single piece, production is extremely simple. It is in this case possible to select a suitable wall thickness, at which a sufficient rigidity of the arrangement is ensured, for the individual flanges. Since, as in the present case, installation space is so tight that only a limited number of stud bolts are available for the individual flanges, the screwing force applied has to be efficiently imparted to the individual flanges. This is made possible by virtue of the fact that the individual flanges which adjoin one another overlap at in each case one peripheral region, specifically in such a way that in the overlapping area their securing bores for attaching them to the cylinder head are aligned with one another. Consequently, the individual flanges at this overlap zone can be simultaneously pressed in the direction of the sealing surface on the cylinder head by means of a single bolt. With a particularly small number of screw connection surfaces, it is in principle conceivable for the individual flanges which bear against one another also to overlap at two peripheral regions which are spaced apart from one another, so that the individual flanges are fitted jointly to the cylinder head not just at one location but rather at two locations in different positions, in each case by means of a single bolt. It should be noted that since the individual flanges in the flange arrangement according to the invention are single pieces, there are no corrosion problems even if particularly inexpensive materials are selected to produce the individual flanges.

In a particularly preferred embodiment of the invention, the individual flanges have a shoulder which reduces their wall thickness and comprises the location of their peripheral regions which overlap, the individual flanges bearing against one another by means of their shoulders. This on the one hand saves installation space at the location of the overlap zone, without reducing the rigidity otherwise possessed by the individual flange at the connection location compared to the individual flange. Secondly, the shoulder produces optionally lateral contact between one individual flange and the other individual flange in the overlap zone, which allows improved positioning of the flanges for the subsequent screw connection. It should be noted that this also applies to the embodiment of the process according to the invention, which is likewise preferred. To achieve an attachment surface of the flange arrangement to the cylinder head and to the subsequent exhaust section, in particular an exhaust manifold, which is as flat as possible, the shoulders are configured in such a manner that the wall thicknesses of the peripheral regions of the individual flanges which lie on top of one another in total correspond to the wall thickness of one individual flange outside the overlap zones.

In another advantageous embodiment of the arrangement according to the invention, its individual flange has a wall thickness which is at least substantially uniform over its entire extent. Furthermore, the overlapping first peripheral region of the individual flange, which covers the corresponding second peripheral region of another individual flange toward the side remote from the cylinder head, is offset toward the side remote from the cylinder head with respect to its overlapping second peripheral region, which covers the corresponding first peripheral region of another individual flange toward the side facing the cylinder head. The result of this is that a shoulder is created in the profile of the individual flange, specifically at the location of the individual flange at which its first peripheral region in the overlap zone covers the other adjoining individual flange on the side remote from the cylinder head, without reducing the wall thickness of the individual flange. This simplifies the process of producing the individual flange, since there is no need for any additional working steps for said reduction in the wall thickness. Producing the individual flange of the flange arrangement can preferably be effected using the process, by the individual flanges being deep-drawn from a flat sheet-metal blank. It is thus simple to achieve the desired profile with the offset peripheral region. Since relatively thin metal sheets are used during the deep-drawing, this form of production has the effect of saving considerable weight in the individual flanges and therefore the flange arrangement as a whole.

In another preferred embodiment of the arrangement according to the invention, the passage opening in the individual flange has an encircling rim on the side remote from the cylinder head. As a result, the rigidity of the individual flange is increased considerably. On account of the increased rigidity, distortion in the flange which would otherwise occur when welding on an exhaust manifold pipe is prevented. During this operation, the exhaust pipe is fitted into the passage opening, with the end face of the exhaust pipe being set back in the passage opening in the flange from its cylinder head side, so that it can be welded in the passage opening. On account of the arrangement of the rim, it is possible to use very thin metal sheets to produce a flange arrangement, since the welding feature of the exhaust pipe is now displaced into the rim. Since the freedom in dimensioning the rim length is relatively great, the exhaust pipe can be positioned with its end face in the rim in such a way that during welding the heat which is generated is not radiated onto the cylinder head side of the flange, which would lead to distortion of that surface of the cylinder head side which forms the sealing surface of the flange. Furthermore, depending on the positioning of the exhaust pipe in the rim, it is also possible to apply wider weld seams, so that particularly good, operationally reliable holding on the flange is also produced by the rim for the exhaust pipe from this side, in addition to its lateral support.

In another preferred refinement of the arrangement according to the invention, the individual flange, on the edge side outside the overlap zone, has a rim which projects perpendicularly toward the side remote from the cylinder head. As a result, the individual flange acquires a particularly high rigidity and tortional stability. On account of the double wall thickness of the flange arrangement in the overlap zone on account of the two individual flanges bearing against one another, the arrangement is likewise provided with a high rigidity at this location, so that there is no need for an additional rim there.

In another preferred embodiment of the arrangement according to the invention, the individual flange, on the edge side of the circumferential region which forms a cover toward the side remote from the cylinder head, has a reinforcing rib which projects in the same direction. This reinforcing rib, which is arranged in such a way that the securing holes are accessible for assembly, increases the wall thickness, which has already been doubled, of the individual flanges bearing against one another in the overlap zone still further.

In another preferred embodiment of the arrangement according to the invention, the individual flange, on the edge side, has a rim which faces away from the cylinder head and runs continuously all the way around with the exception of the second peripheral region which is covered by another individual flange toward the side remote from the cylinder head. On account of this particular configuration of the individual flange with regard to the rim profile, the rim of one of the two adjoining individual flanges extends over the entire overlap zone, with the result that the flange arrangement is made particularly rigid at every location.

In another preferred refinement of the process according to the invention, the outer contour, the securing bores and the passage opening of the individual flanges are produced by punching. The use of this process makes the respective individual flanges, and therefore the entire flange arrangement, particularly simple to produce, it being possible both to form the outer contour and the securing bores as well as the passage openings, which during fitting of the flange arrangement to the cylinder head directly adjoin the respective exhaust-gas outlet, in a single operation.

In another preferred refinement of the process according to the invention, to form the shoulder of the individual flange, the latter is stamped at the corresponding location of its periphery. The flange material which has been displaced by the stamping operation and projects laterally beyond the edge of the flange is then cut off. The stamping and cutting operations are working steps which are simple to carry out, with in particular the stamping ensuring very accurate contours. There is in this case no need for remachining steps to improve the surface quality and contour quality.

In a particularly preferred embodiment of the process according to the invention, the cutting of the flange takes place in a final punching operation, in which the flange contour is precision-punched after it has been rough-prepunched. The individual steps of machining the flange, i.e. the tube punching, the stamping and the precision-punching can be effected using a progressive tool. It is also possible, reducing the outlay on apparatus and the production cycle time, for at least the stamping and the precision-punching, to follow one another in a single tool without needing transport between working stations. This represents a very simple and economical form of production.

Another preferred refinement of the process according to the invention consists in the fact that after the deep-drawing of the flange the securing bores and the passage opening are punched out. The operation of punching out after the flange has been deep-drawn has the positive effect of ensuring that the securing bores and the passage opening retain the desired, intended contour and the diameter which has previously been set. In other cases, undefined bore and passage opening contours would be produced.

In another preferred embodiment of the process according to the invention, a rim which faces toward the side remote from the cylinder head is formed by the deep-drawing operation at the same time as the first peripheral region on the edge side of the flange and around the passage opening is being formed. As a result, the entire contour of the individual flange and the reinforcing apparatus formed by the rim are produced simultaneously in one working step, which represents an economical process, saves cycle time and also reduces the outlay on equipment.

### BRIEF DESCRIPTION OF THE DRAWINGS

In the text which follows, the flange arrangement according to the invention and the corresponding process according to the invention are explained in more detail on the basis of a plurality of exemplary embodiments illustrated in the drawings, in which:

FIG. 1a shows a perspective view of an individual flange produced in accordance with the invention with a shoulder reducing its wall thickness,

FIG. 1b shows a lateral longitudinal section through the individual flange from FIG. 1a,

FIG. 1a shows a perspective view of an individual flange produced in accordance with the invention with a shoulder reducing its wall thickness,

FIG. 1b shows a lateral longitudinal section through the individual flange from FIG. 1a,

FIG. 2 shows a perspective plan view of a flange arrangement according to the invention which comprises four individual flanges and has been produced in accordance with the pattern of the individual flange from FIG. 1a,

FIG. 3 shows a perspective view of an individual flange produced in accordance with the invention of a flange arrangement, with a raised rim and with two securing bores per overlapping peripheral region,

FIG. 4 shows a flange arrangement according to the invention, which has been secured to a cylinder head, using individual flanges as shown in FIG. 3, in the form of a plan view,

FIG. 5a shows a plan view of a flange arrangement according to the invention with three securing bores per individual flange and one peripheral region which has a web-like profile and extends into the overlap zone toward the other individual flange,

FIG. 5b shows a perspective view of the flange arrangement from FIG. 5a.

### DETAILED DESCRIPTION OF THE INVENTION

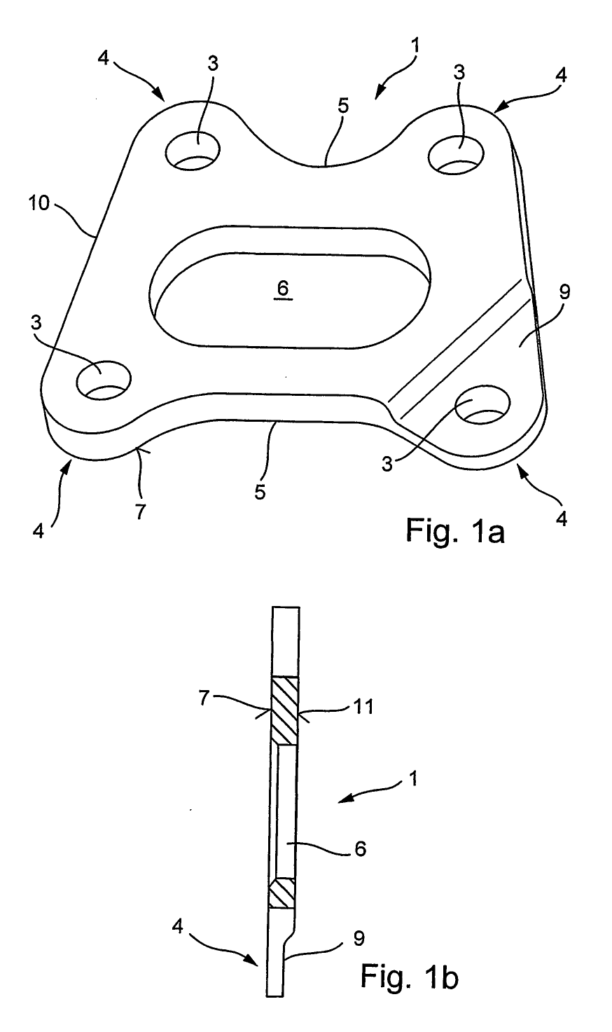

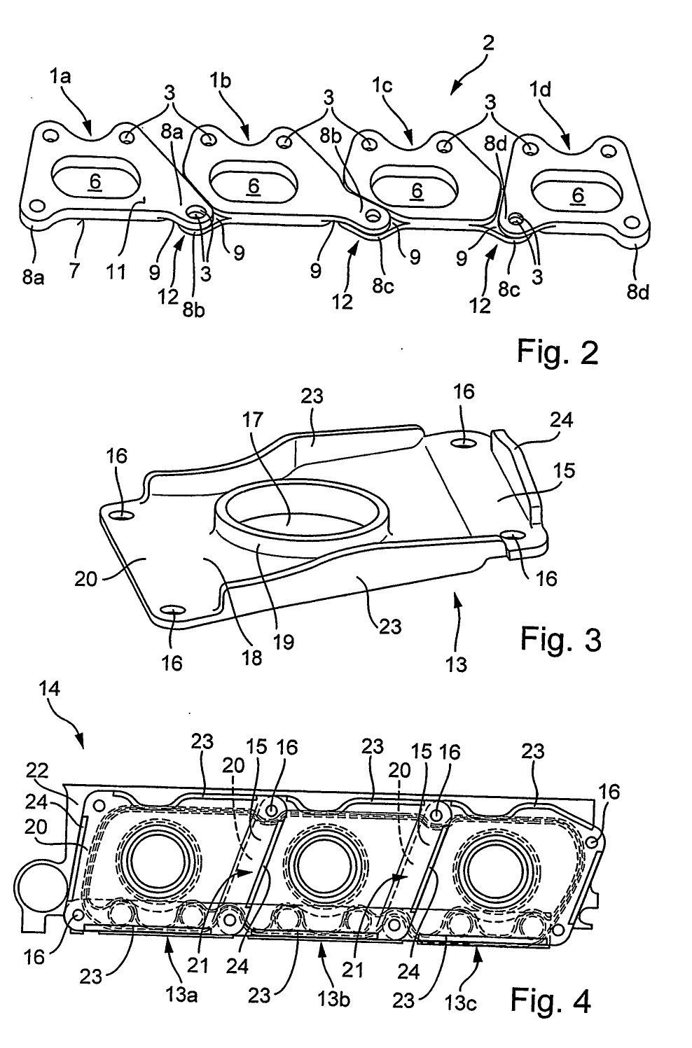

FIG. 1a and FIG. 1b illustrate an individual flange 1 which is assigned to a flange arrangement 2 according to the invention that can be seen, for example, in FIG. 2. The individual flange 1 is screwed to the exhaust-gas side of an engine cylinder head by means of stud bolts, for which purpose in these exemplary embodiments four securing holes 3 are formed on the individual flange 1. The individual flange 1, which when seen from above is approximately trapezoidal, has these securing bores 3 in its corner regions 4. The individual flange 1 also has an indentation 5 on each of two opposite narrow sides, with the result that the individual flange 1, on account of the missing flange material, is optimized in terms of weight. In the centre, the individual flange 1 has a vacant passage opening 6 which directly adjoins an exhaust-gas outlet on the cylinder head. That side 7 of the respective individual flange 1 which faces the cylinder head forms the sealing surface of the individual flange 1 on the cylinder head. The individual flange 1 has a peripheral region 8 which comprises one of the corner regions 4 which has a shoulder 9 which reduces the wall thickness. The individual flange 1, which is of thick-walled design in order to satisfy the demands in terms of rigidity, is produced by punching, forming the outer contour 10, the securing bores 3 and the passage opening 6. The shoulder 9 is stamped to its nominal dimension, after which the flange material which has been displaced by the stamping operation and projects laterally beyond the edge of the flange 1 is cut off. It is expedient for this cutting operation also to be carried out in a punching operation which can be carried out by the same tool which has previously produced the contours of the flange 1 and of the bores 3.

The flange arrangement 2 as shown in FIG. 2 now comprises four individual flanges 1a to 1d. Whereas the individual flanges 1a and 1d in each case only have one peripheral region 8a and 8d with a shoulder 9, the individual flanges 1b and 1c located between them each have two peripheral regions 8b and 8c which are equipped with a shoulder 9. The shoulders 9 of the peripheral regions 8c in this case face in the direction away from the cylinder head, while the peripheral regions 8b of the individual flange 1b are formed in such a way that their shoulders 9 face in alternate directions. To form the flange arrangement 2, the individual flanges 1a to 1d are then placed with their shoulders 9 bearing against one another in order, with the peripheral regions 8a to 8d overlapping. In this case, the shoulder 9 of the peripheral region 8a which faces the cylinder head bears against the shoulder 9 of the peripheral region 8b of the individual flange 1b which is remote from the cylinder head, while the other shoulder 9, facing the cylinder head, which is of elongate web-like configuration, of the individual flange 1b comes to bear against the shoulder 9, which is remote from the cylinder head and is of substantially corresponding shape, of the peripheral region 8c of the individual flange 1c. Finally, the shoulder 9, which faces the cylinder head, of the peripheral region 8d of the individual flange 1d bears against the further shoulder 9, remote from the cylinder head, of the other peripheral region 8c. The peripheral regions 8a to 8d now bear against one another in such a manner that the securing bores 3 which are formed in the peripheral regions 8a to 8d are aligned with one another. In this position, the flange arrangement 2 is screwed to the cylinder head, with the stud bolts fitted to the cylinder head penetrating through the securing bores 3 and with an exhaust manifold which adjoins the side 11 of the individual flanges 1a to 1d which is remote from the cylinder head being screwed on at the same time. As a result, the flange arrangement 2 in the respective overlap zone 12 of the overlapping peripheral regions 8a to 8d of the individual flanges 1a to 1d, is screwed onto the cylinder head by means of in each case a single stud bolt, with the result that it is possible to save three stud bolts and therefore three securing locations compared to all the individual flanges 1a to 1d being screwed on separately, thereby saving space and allowing the flange arrangement 2 to be of more compact configuration. As a model for all the exemplary embodiments described below, the flange arrangement 2 is screwed to the cylinder head under torque control, in such a manner that a relative movement between the individual flanges 1a-d—even in the overlap region—is permitted. This is necessary in particular in the case of compact exhaust manifolds with airgap insulation, in order to permit thermal expansion of the manifold on the cylinder head and thereby to prevent strength-influencing stresses in the manifold which could otherwise occur.

FIGS. 3 and 4 illustrate a variant of the flange arrangement according to the invention, with the individual flanges 13 of a flange arrangement 14 now being deep-drawn with respect to the individual flanges 1a to 1d and therefore the overall flange arrangement 2, which means that they have a lesser wall thickness, which leads to a considerable reduction in the weight of the flange arrangement 14. The individual flanges 13a to 13c of the flange arrangement 14 have a wall thickness which is at least substantially uniform over the entire extent of the respective individual flange 13. A peripheral region 15 of the individual flanges 13a and 13b, which extends over the entire width of the respective flange 13a and 13b, where it includes two securing bores 16, is offset out of the plane of the flange 13a and 13b by the deep-drawing operation. The individual flanges 13 which have been drawn from a planar sheet-metal blank have a passage opening 17 approximately in the center, and this passage opening 17 is directly surrounded, on the side 18 of the flanges 13 remote from the cylinder head, by a continuously encircling rim 19 which projects perpendicularly. On the other wide side, a second peripheral region 20, which is not offset and likewise includes two securing bores 16, lies opposite the first, offset peripheral region 15 of the flange 13a and 13b. To form the flange arrangement 14, the individual flanges 13a to 13c are made to bear against one another in order in such a way that their peripheral regions 15 and 20 overlap. In this case, the individual flanges 13a to 13c, as can be seen from FIG. 4, form overlap zones 21, with the overlapping first peripheral region 15 of the individual flange 13a covering the second peripheral region 20 of the individual flange 13b toward the side 18 remote from the cylinder head. The first peripheral region 15 of the individual flange 13b covers the second peripheral region 20 of the individual flange 13c toward the side 18 remote from the cylinder head. The outer first peripheral region 15 of the individual flange 13c and the outer second peripheral region 20 of the individual flange 13a of course do not form an overlap zone 21. At this point, it should be noted once again that with the exception of the individual flange 13c, the two individual flanges 13a and 13b are formed in such a way that their first peripheral regions 15 are offset toward the side 18 remote from the cylinder head with respect to their second peripheral regions 20. In this flange arrangement 14 composed of the individual flanges 13a to 13c too, the securing bores 16 arranged in the corresponding peripheral regions 15 and 20 are aligned in the overlap zones 21.

To secure the flange arrangement to a cylinder head 22, it is screwed to the cylinder head 22, in the customary way using stud bolts which penetrate through the securing bores 16, together with the exhaust manifold which adjoins it on the exhaust side and is not illustrated here. In this described variant of the invention, in the case of a flange arrangement 14 comprising three individual flanges 13, it is possible to save four stud bolts, and therefore four securing locations, compared to individual flanges which are screwed on separately via four securing bores. This leads to a particularly compact design of the flange arrangement 14, which can be secured to the cylinder head 22 even when installation conditions in the engine compartment are particularly tight.

Moreover, between the first peripheral region 15 and the second peripheral region 20, the individual flange 13a to 13c has, on the edge side outside the overlap zones 21, a rim 23 which projects perpendicularly toward the side 18 remote from the cylinder head. This rim 23 formed on the longitudinal side of the individual flange 13 is used to reinforce the flange 13. In addition, the individual flange 13a and 13b has a reinforcing rib 24 which projects in the same direction as the rim 23 and is arranged between the securing bores 16 on the edge side of the first peripheral region 15, which forms a cover toward the side 18 remote from the cylinder head. This reinforcing rib 24 is likewise located on the edge side of the second peripheral region 20 of the flange 13a and of the peripheral region 15 of the individual flange 13c. To produce an individual flange 13a to 13c, after the deep-drawing operation, both the passage opening and the securing bores 16 are punched out. The rims 19 and 23 can be produced during this deep-drawing operation in the same way and in the same tool.

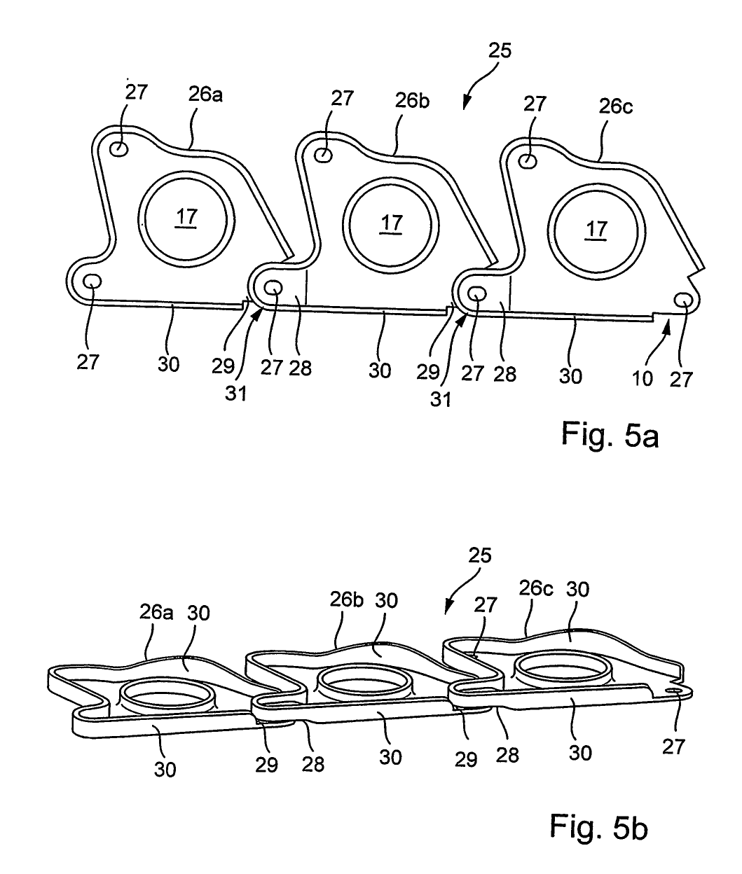

The flange arrangement 25 shown in FIGS. 5a and 5b illustrates another variant of the flange arrangement according to the invention. The flange arrangement 25 is composed of three individual flanges 26a to 26c, which are approximately triangular in form, each have three securing bores 27 and, like the individual flanges 13 in the previous exemplary embodiment, are deep-drawn from a planar sheet-metal blank. The individual flanges 26b and 26c have the offset, first peripheral region 28 in the corner region of the bottom longitudinal side. The second peripheral region 29 is formed in the opposite corner region of the longitudinal side. With the exception of this second peripheral region 29, a rim 30 runs along the edge side of the outer contour 10 of the individual flange 26; this rim 30 faces away from the cylinder head and is used to reinforce the individual flange. Therefore, unlike in the previous exemplary embodiment, its first peripheral region 28 is likewise enclosed by a rim 30. As has already been mentioned in connection with the previous exemplary embodiment, the first peripheral regions 28 of one individual flange 26 form the overlap zone 31 with the second peripheral regions 29 of the other individual flange; in this case, the first peripheral region 28 extends in the manner of a tongue from the individual flange 26 toward the other, adjoining individual flange 26 and projects into the region in which the rim is absent. In this case, the peripheral regions 28 of the individual flanges 26a-c run collinearly with respect to one another. This creates a multi-link strip form of the flange arrangement 25 in this region, by which openings in the cast cylinder head which are required for the casting operation can be covered in a gastight manner. The described flange arrangement 25 has a minimal number of securing locations or securing bores 27, with two securing locations being eliminated by the overlap compared to the separate screw connection of the individual flanges, so as to save installation space. The result of this is that on the one hand the assembly time of the flange arrangement 25 can be very quick, on account of the small number of securing locations, and on the other hand it is possible to form a very “slimmed-down” outer contour 10, which on account of the associated weight reduction leads to a very lightweight flange arrangement 25 of particularly small construction.

1. A flange arrangement of an engine cylinder head, wherein the flange arrangement (2, 14, 25) has at least two single-piece individual flanges (1a-d, 13a-c, 26), which bear against one another with in each case at least one peripheral region (8a-d, 15, 20, 28, 29) overlapping, in such a manner that in the overlapping area their securing bores (3, 16, 27) for attaching them to the cylinder head (22) are aligned.

2. The arrangement as claimed in claim 1, wherein the individual flanges (1a-d) have a shoulder (2) which reduces their wall thickness and comprises the location of their peripheral regions (8a-d) which overlap, the individual flanges (1a-d) bearing against one another by means of their shoulders (9).

3. The arrangement as claimed in claim 1, wherein the individual flange (13a-c, 26) has a wall thickness which is at least substantially uniform over its entire extent, and in that the overlapping first peripheral region (15, 28) of the individual flange (13a-c, 26), which covers the corresponding second peripheral region (20, 29) of another individual flange (13a-c, 26) toward the side (18) remote from the cylinder head, is offset toward the side (18) remote from the cylinder head with respect to its overlapping second peripheral region (20, 29), which covers the corresponding first peripheral region (15, 28) of another individual flange (13a-c, 26) toward the side facing the cylinder head.

4. The arrangement as claimed in claim 1, wherein the passage opening (6, 17) in the individual flange (1a-d, 13a-c, 26) has an encircling rim (19) on the side (18) remote from the cylinder head.

5. The arrangement as claimed in claim 1, wherein the individual flange (1a-d, 13a-c, 26), on the edge side outside the overlap zone (12, 21, 31), has a rim (23, 30) which projects perpendicularly toward the side (18) remote from the cylinder head.

6. The arrangement as claimed in claim 5, wherein the individual flange (1a-d, 13a-c), on the edge side of the circumferential region (8a, 8b, 8d, 15) which forms a cover toward the side (11, 18) remote from the cylinder head, has a reinforcing rib (24) which projects in the same direction.

7. The arrangement as claimed in claim 1, wherein the individual flange (13a-c, 26), on the edge side, has a rim (23, 30) which faces away from the cylinder head (22) and runs continuously all the way around with the exception of the second peripheral region (20, 29) which is covered by another individual flange (13a-c, 26) toward the side (18) remote from the cylinder head.

8. A process for producing a flange arrangement of an engine cylinder head, wherein the flange arrangement (2, 14, 25) is composed of single-piece individual flanges (1a-d, 13a-c, 26), and in that the individual flanges (1a-d, 13a-c, 26) are placed against one another with in each case at least one peripheral region (8a-d, 15, 20, 28, 29) overlapping, in such a manner that the securing bores (3, 16, 27) which are formed in the peripheral region (8a-d, 15, 20, 28, 29) of the individual flanges (1a-d, 13a-c, 26) are aligned with one another.

9. The method as claimed in claim 8, wherein the outer contour (10), the securing bores (3, 16, 27) and the passage opening (6, 17) of the individual flanges (1a-d, 13a-c, 26) are produced by punching.

10. The method as claimed in claim 8, wherein the individual flanges (1a-d) are designed with at least one shoulder (9) which reduces the wall thickness and comprises the location of their overlapping peripheral regions (8a-d), and in that the individual flanges (1a-d) are placed with their shoulders (9) against one another.

11. The method as claimed in claim 10, wherein to form the shoulder (9), the individual flange (1a-d) is stamped at the corresponding location, and in that the flange material which has been displaced by the stamping operation and projects laterally beyond the edge of the flange (1a-d) is cut off.

12. The process as claimed in claim 11, wherein the cutting of the flange (1a-d) takes place in a final punching operation, in which the flange contour (10) is precision-punched after it has been rough-prepunched.

13. The process as claimed in claim 8, wherein the individual flanges (13a-c, 26) are deep-drawn from a planar sheet-metal blank, with an overlapping first peripheral region (15, 28) of the individual flange (13a-c, 26), which covers the corresponding second peripheral region (20, 29) of another individual flange (13a-c, 26) toward the side (18) remote from the cylinder head, being formed so as to be offset toward the side (18) remote from the cylinder head with respect to its overlapping second peripheral region (20, 29), which covers the corresponding first peripheral region (15, 28) of another individual flange (13a-c, 26) toward the side facing the cylinder head.

14. The process as claimed in claim 13, wherein after the deep-drawing of the flange (13a-c, 26) the securing bores (16, 27) and the passage opening (17) are punched out.

15. The process as claimed in claim 13, wherein a rim (19, 23, 30) which faces toward the side (18) remote from the cylinder head is formed by the deep-drawing operation at the same time as the first peripheral region (15, 28) on the edge side of the flange (13a-c, 26) and around the passage opening (17) is being formed.
